(19) United States
(12) Patent Application Publication
(10) Pub. No.: US 2022/0411891 A1
(43) Pub. Date: Dec. 29, 2022

(54) ROLLING BEARING

(71) Applicant: NTN Corporation, Osaka (JP)

(72) Inventors: Takashi KAWAI, Iwata-shi, Shizuoka (JP); Chikara OHKI, Kuwana-shi, Mie (JP); Masahiro YAMADA, Kuwana-shi, Mie (JP)

(21) Appl. No.: 17/764,018

(22) PCT Filed: Sep. 9, 2020
(86) PCT No.: PCT/JP2020/034079

§ 371 Date: Mar. 25, 2022

(30) Foreign Application Priority Data
Sep. 26, 2019 (JP) 2019-175946

(51) Int. Cl. C21D 9/40; C23C 8/32; C21D 9/36; C21D 1/06; F16C 19/06; F16C 19/26; F16C 19/36; F16C 33/32; F16C 33/34; F16C 33/58; F16C 33/62; F16C 33/64; C21D 1/18; C21D 1/26

(52) U.S. Cl. CPC C21D 9/40; C23C 8/32; C21D 9/36; C21D 1/06; F16C 19/06; F16C 19/26; F16C 19/364; F16C 33/32; F16C 33/34; F16C 33/585; F16C 33/62; F16C 33/64; C21D 1/18; C21D 1/26; C21D 2211/008; C21D 2261/00; F16C 2204/66; F16C 2204/70; F16C 2223/16; F16C 2223/18; F16C 2240/48; F16C 2240/60; F16C 2240/90; F16C 2361/65

(57) ABSTRACT

A rolling bearing is a tapered roller bearing, a cylindrical roller bearing, or a deep groove ball bearing including an inner ring, an outer ring, and a rolling element, each of the inner ring, the outer ring, and the rolling element being composed of a steel, the rolling bearing having a quench-hardened layer in at least one of an inner ring raceway surface of the inner ring, an outer ring raceway surface of the outer ring, and a rolling contact surface of the rolling element. A ratio of a total area of a plurality of martensite crystal grains in the quench-hardened layer is more than or equal to 70%. The plurality of martensite crystal grains are classified into a first group and a second group. An average grain size of the martensite crystal grains belonging to the first group is less than or equal to 0.97 μm.

### TECHNICAL FIELD

The present invention relates to a rolling bearing. More particularly, the present invention relates to a tapered roller bearing, a cylindrical roller bearing, or a deep groove ball bearing.

### BACKGROUND ART

A rolling fatigue life of a rolling bearing is improved by carbonitriding a surface of a bearing part (a raceway surface of each of an inner ring and an outer ring as well as a rolling contact surface of a rolling element) as described in PTL 1 (Japanese Patent No. 5592540). Moreover, the rolling fatigue life of the rolling bearing is improved by attaining fine prior austenite grains in the surface of the bearing part as described in PTL 2 (Japanese Patent No. 3905430).

### CITATION LIST

### Patent Literature

PTL 1: Japanese Patent No. 5592540

PTL 2: Japanese Patent No. 3905430

### SUMMARY OF INVENTION

### Technical Problem

A steel used for the bearing part is generally quenched. That is, a quench-hardened layer having a structure mainly composed of a martensite phase is formed in the surface of the bearing part. However, it has not been conventionally known how states of martensite crystal grains affect the rolling fatigue life of the bearing part.

In a transmission or differential for an automobile, a low-viscosity lubricating oil tends to be applied in order to improve fuel efficiency or an amount of lubricating oil in a unit tends to be reduced, and such tendencies are also considered to continue in future. Therefore, in a rolling bearing used in such a severe lubricating state, a material matrix of a surface layer of a quench-hardened layer needs to be composed of a stronger structure. Further, in response to downsizing of units, the size (outer diameter or width) of the rolling bearing is required to be decreased; however, an output tends to be high due to motor assisting or provision of a turbo mechanism and an applied load to the rolling bearing (a ratio of the applied load to the bearing rated load) tends to be increased, so that a longer life of the rolling bearing is required. Further, in view of increased popularity of urban car sharing in future, frequency of use and travel distance of an automobile tend to be increased, so that a longer life of the rolling bearing has been desired more than ever.

A maximum contact pressure is applied to a rolling surface (raceway surface or rolling contact surface) at a central position in a rolling surface axial direction. Therefore, in order to attain a long life of the rolling bearing, it is particularly important to improve the material structure of the quench-hardened layer in the rolling surface at the central position in the rolling surface axial direction.

The present invention has been made in view of the above-described problem of the conventional art. More specifically, the present invention is to provide a rolling bearing having an improved rolling fatigue life.

### Solution to Problem

A rolling bearing according to a first implementation of the present invention is a tapered roller bearing, a cylindrical roller bearing, or a deep groove ball bearing including an inner ring, an outer ring, and a rolling element, each of the inner ring, the outer ring, and the rolling element being composed of a steel, the rolling bearing having a quench-hardened layer in at least one of an inner ring raceway surface of the inner ring, an outer ring raceway surface of the outer ring, and a rolling contact surface of the rolling element. The quench-hardened layer includes a plurality of martensite crystal grains and a plurality of austenite crystal grains. A ratio of a total area of the plurality of martensite crystal grains in the quench-hardened layer is more than or equal to 70%. The plurality of martensite crystal grains are classified into a first group and a second group. A minimum value of crystal grain sizes of the martensite crystal grains belonging to the first group is larger than a maximum value of crystal grain sizes of the martensite crystal grains belonging to the second group. A value obtained by dividing a total area of the martensite crystal grains belonging to the first group by the total area of the plurality of martensite crystal grains is more than or equal to 0.5. A value obtained by dividing, by the total area of the plurality of martensite crystal grains, a total area of the martensite crystal grains belonging to the first group except for a martensite crystal grain that has a minimum crystal grain size and that belongs to the first group is less than 0.5. An average grain size of the martensite crystal grains belonging to the first group is less than or equal to 0.97 μm. A hardness of the quench-hardened layer is more than or equal to 670 Hv in a surface of the quench-hardened layer at a central position in a rolling surface axial direction. A volume ratio of the austenite crystal grains in the quench-hardened layer is less than or equal to 30% in the surface of the quench-hardened layer at the central position in the rolling surface axial direction.

In the rolling bearing according to the first implementation of the present invention, an average aspect ratio of the martensite crystal grains belonging to the first group may be less than or equal to 2.57.

A rolling bearing according to a second implementation of the present invention is a tapered roller bearing, a cylindrical roller bearing, or a deep groove ball bearing including an inner ring, an outer ring, and a rolling element, each of the inner ring, the outer ring, and the rolling element being composed of a steel, the rolling bearing having a quench-hardened layer in at least one of an inner ring raceway surface of the inner ring, an outer ring raceway surface of the outer ring, and a rolling contact surface of the rolling element. The quench-hardened layer includes a plurality of martensite crystal grains and a plurality of austenite crystal grains. A ratio of a total area of the plurality of martensite crystal grains in the quench-hardened layer is more than or equal to 70%. The plurality of martensite crystal grains are classified into a third group and a fourth group. A minimum value of crystal grain sizes of the martensite crystal grains belonging to the third group is larger than a maximum value of crystal grain sizes of the martensite crystal grains belonging to the fourth group. A value obtained by dividing a total area of the martensite crystal grains belonging to the third group by the total area of the plurality of martensite crystal grains is more than or equal to 0.7. A value obtained by dividing, by the total area of the plurality of martensite crystal grains, a total area of the martensite crystal grains belonging to the third group except for a martensite crystal grain that has a minimum crystal grain size and that belongs to the third group is less than 0.7. An average grain size of the martensite crystal grains belonging to the third group is less than or equal to 0.75 μm. A hardness of the quench-hardened layer is more than or equal to 670 Hv in a surface of the quench-hardened layer at a central position in a rolling surface axial direction. A volume ratio of the austenite crystal grains in the quench-hardened layer is less than or equal to 30% in the surface of the quench-hardened layer at the central position in the rolling surface axial direction.

In the rolling bearing according to the second implementation of the present invention, an average aspect ratio of the martensite crystal grains belonging to the third group may be less than or equal to 2.45.

In the rolling bearing according to each of the first and second implementations of the present invention, the quench-hardened layer may contain nitrogen. An average nitrogen concentration of the quench-hardened layer may be more than or equal to 0.05 mass % between the surface and a position at a distance of 10 μm from the surface.

In the rolling bearing according to each of the first and second implementations of the present invention, an average carbon concentration of the quench-hardened layer may be more than or equal to 0.5 mass % between the surface and a position at a distance of 10 μm from the surface.

In the rolling bearing according to each of the first and second implementations of the present invention, the steel may be a high carbon chromium bearing steel SUJ2 defined in JIS.

### Advantageous Effects of Invention

According to the rolling bearing according to each of the first and second implementations of the present invention, a rolling fatigue life can be improved.

### BRIEF DESCRIPTION OF DRAWINGS

FIG. 1 is a cross sectional view of a rolling bearing 100.

FIG. 2 is an enlarged cross sectional view of an inner ring 10 in the vicinity of an inner ring raceway surface 10c.

FIG. 3 is a cross sectional view of a rolling bearing 200.

FIG. 4 is a cross sectional view of a rolling bearing 300.

FIG. 5 is a process chart showing a method for manufacturing inner ring 10.

FIG. 6 shows an EBSD image at a cross section of a sample 1.

FIG. 7 shows an EBSD image at a cross section of a sample 2.

FIG. 8 shows an EBSD image at a cross section of a sample 3.

FIG. 9 is a graph showing a relation between an average grain size of martensite crystal grains and a rolling fatigue life.

FIG. 10 is a graph showing a relation between an average aspect ratio of the martensite crystal grains and the rolling fatigue life.

FIG. 11 is a graph showing a relation between a maximum contact pressure and an indentation depth.

FIG. 12 is a graph showing a relation between the average grain size of the martensite crystal grains and a static load capacity.

FIG. 13 is a graph showing a relation between the average aspect ratio of the martensite crystal grains and the static load capacity.

### DESCRIPTION OF EMBODIMENTS

Details of embodiments will be described with reference to figures. In the below-described figures, the same or corresponding portions are denoted by the same reference characters, and the same description will not be repeated.

(Configuration of Rolling Bearing according to Embodiment)

Hereinafter, a configuration of a rolling bearing (hereinafter, referred to as “rolling bearing 100”) according to an embodiment will be described.

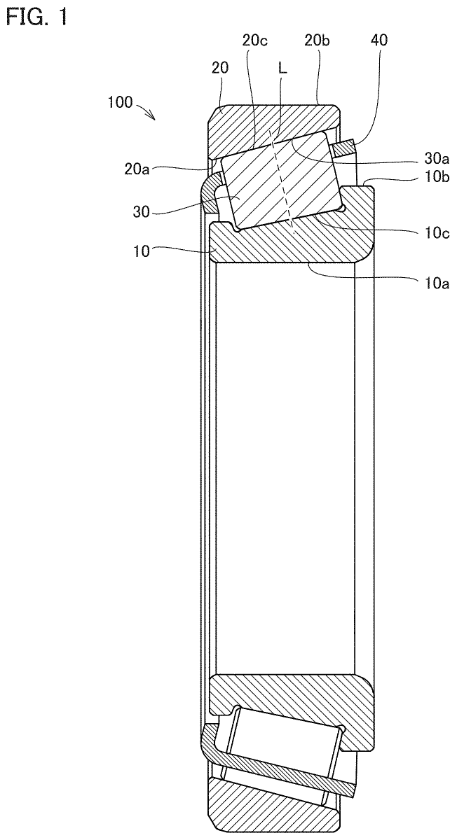

FIG. 1 is a cross sectional view of rolling bearing 100. As shown in FIG. 1, rolling bearing 100 is a tapered roller bearing. Rolling bearing 100 includes an inner ring 10, an outer ring 20, rolling elements 30, and a cage 40.

Inner ring 10 has a ring-like shape. Inner ring 10 has an inner circumferential surface 10a and an outer circumferential surface 10b. Each of inner circumferential surface 10a and outer circumferential surface 10b extends along a circumferential direction of inner ring 10. Inner circumferential surface 10a faces the central axis side of inner ring 10, and outer circumferential surface 10b faces the side of inner ring 10 opposite to the central axis side. That is, outer circumferential surface 10b is a surface opposite to inner circumferential surface 10a in a radial direction of inner ring 10. Outer circumferential surface 10b includes an inner ring raceway surface 10c. Inner ring raceway surface 10c is in contact with each rolling element 30.

Outer ring 20 has a ring-like shape. Outer ring 20 has an inner circumferential surface 20a and an outer circumferential surface 20b. Each of inner circumferential surface 20a and outer circumferential surface 20b extends along a circumferential direction of outer ring 20. Inner circumferential surface 20a faces the central axis side of outer ring 20, and outer circumferential surface 20b faces the side of outer ring 20 opposite to the central axis side. That is, outer circumferential surface 20b is a surface opposite to inner circumferential surface 20a in a radial direction of outer ring 20. Inner circumferential surface 20a includes an outer ring raceway surface 20c. Outer ring raceway surface 20c is in contact with each rolling element 30. Outer ring 20 is disposed external to inner ring 10 such that inner circumferential surface 20a faces outer circumferential surface 10b.

Rolling element 30 has a shape of truncated cone. That is, rolling element 30 is a tapered roller. Rolling element 30 has an outer circumferential surface 30a. Outer circumferential surface 30a serves as a rolling contact surface of rolling element 30. Rolling element 30 is disposed between inner ring 10 and outer ring 20 such that outer circumferential surface 30a is in contact with inner ring raceway surface 10c and outer ring raceway surface 20c.

Each of inner ring 10, outer ring 20 and rolling element 30 is composed of a steel. This steel is, for example, a high carbon chromium bearing steel SUJ2 defined in JIS (JIS G 4805: 2008). However, each of inner ring 10, outer ring 20 and rolling element 30 may be composed of another steel (high carbon chromium bearing steel SUJ3 defined in JIS; 52100 defined in ASTM; 100Cr6 defined in DIN; or GCrl5 defined in GB). Inner ring 10, outer ring 20, and rolling element 30 may be composed of different steels.

The central position of rolling bearing 100 in a rolling surface axial direction is a position at which an imaginary straight line L (indicated by a dotted line in FIG. 1) that passes through the center in a direction along the central axis of rolling clement 30 and that is orthogonal to the central axis intersects inner ring raceway surface 10c, outer ring raceway surface 20c, or outer circumferential surface 30a (raceway surface of rolling element 30). From another viewpoint, it can be said that the central position in the rolling surface axial direction is a position on a rolling surface (inner ring raceway surface 10c, outer ring raceway surface 20c, or outer circumferential surface 30a) to which the maximum contact pressure is applied.

Cage 40 holds rolling elements 30 such that an interval between two adjacent rolling elements 30 in the circumferential direction of cage 40 falls within a predetermined range. Cage 40 is disposed between inner ring 10 and outer ring 20.

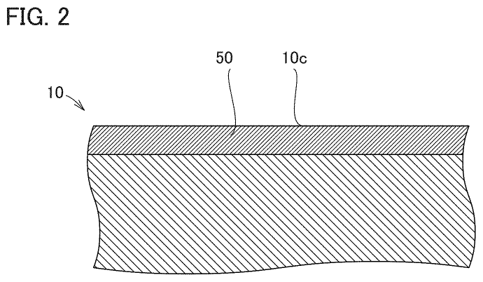

FIG. 2 is an enlarged cross sectional view of inner ring 10 in the vicinity of inner ring raceway surface 10c. As shown in FIG. 2, inner ring 10 has a quench-hardened layer 50 in inner ring raceway surface 10c. Quench-hardened layer 50 is a layer hardened by performing quenching. Quench-hardened layer 50 includes a plurality of martensite crystal grains.

When a deviation is more than or equal to 15° between the crystal orientation of a first martensite crystal grain and the crystal orientation of a second martensite crystal grain adjacent to the first martensite crystal grain, the first and second martensite crystal grains are different martensite crystal grains. On the other hand, when the deviation is less than 15° between the crystal orientation of the first martensite crystal grain and the crystal orientation of the second martensite crystal grain adjacent to the first martensite crystal grain, the first and second martensite crystal grains constitute one martensite crystal grain.

Quench-hardened layer 50 has a structure mainly composed of the martensite phase. More specifically, a ratio of a total area of the plurality of martensite crystal grains in quench-hardened layer 50 is more than or equal to 70%. The ratio of the total area of the plurality of martensite crystal grains in quench-hardened layer 50 may be more than or equal to 80%.

In addition to the martensite crystal grains, quench-hardened layer 50 includes austenite crystal grains, ferrite crystal grains, and cementite (Fe₃C) crystal grains. A volume ratio of the austenite crystal grains in quench-hardened layer 50 is preferably less than or equal to 30%. The volume ratio of the austenite crystal grains in quench-hardened layer 50 is more preferably less than or equal to 20%.

It should be noted that the volume ratio of the austenite crystal grains in quench-hardened layer 50 is measured by an X-ray diffraction method. More specifically, the volume ratio of the austenite crystal grains in quench-hardened layer 50 is calculated based on a ratio of the X-ray diffraction intensity of the austenite phase and the X-ray diffraction intensity of the other phases included in quench-hardened layer 50. The volume ratio of the austenite crystal grains in quench-hardened layer 50 is measured between the surface (inner ring raceway surface 10c) of quench-hardened layer 50 at the central position in the rolling surface axial direction and a position at a distance of 50 μm from the surface.

The plurality of martensite crystal grains are classified into a first group and a second group. A minimum value of crystal grain sizes of the martensite crystal grains belonging to the first group is larger than a maximum value of crystal grain sizes of the martensite crystal grains belonging to the second group.

A value obtained by dividing a total area of the martensite crystal grains belonging to the first group by the total area of the plurality of martensite crystal grains (the sum of the total area of the martensite crystal grains belonging to the first group and the total area of the martensite crystal grains belonging to the second group) is more than or equal to 0.5.

A value obtained by dividing, by the total area of the plurality of martensite crystal grains, the total area of the martensite crystal grains belonging to the first group except for a martensite crystal grain that has a minimum crystal grain size and that belongs to the first group is less than 0.5.

From another viewpoint, it can be said that the plurality of martensite crystal grains are assigned to the first group in the order from one having the largest crystal grain size. The assignment to the first group is ended when the total area of the martensite crystal grains assigned to the first group until then becomes 0.5 or more time as large as the total area of the plurality of martensite crystal grains. A remainder of the plurality of martensite crystal grains are assigned to the second group.

An average grain size of the martensite crystal grains belonging to the first group is less than or equal to 0.97m. The average grain size of the martensite crystal grains belonging to the first group is preferably less than or equal to 0.90 μm. The average grain size of the martensite crystal grains belonging to the first group is more preferably less than or equal to 0.85 μm.

An aspect ratio of each of the martensite crystal grains belonging to the first group is less than or equal to 2.57. The aspect ratio of each of the martensite crystal grains belonging to the first group is preferably less than or equal to 2.50. The aspect ratio of each of the martensite crystal grains belonging to the first group is more preferably less than or equal to 2.45.

The plurality of martensite crystal grains may be classified into a third group and a fourth group. A minimum value of crystal grain sizes of the martensite crystal grains belonging to the third group is larger than a maximum value of crystal grain sizes of the martensite crystal grains belonging to the fourth group.

A value obtained by dividing a total area of the martensite crystal grains belonging to the third group by the total area of the plurality of martensite crystal grains (the sum of the total area of the martensite crystal grains belonging to the third group and the total area of the martensite crystal grains belonging to the fourth group) is more than or equal to 0.7.

A value obtained by dividing, by the total area of the plurality of martensite crystal grains, the total area of the martensite crystal grains belonging to the third group except for a martensite crystal grain that has a minimum crystal grain size and that belongs to the third group is less than 0.7.

From another viewpoint, it can be said that the plurality of martensite crystal grains are assigned to the third group in the order from one having the largest crystal grain size. The assignment to the third group is ended when the total area of the martensite crystal grains assigned to the third group until then becomes 0.7 or more time as large as the total area of the plurality of martensite crystal grains. A remainder of the plurality of martensite crystal grains are assigned to the fourth group.

An average grain size of the martensite crystal grains belonging to the third group is less than or equal to 0.75 μM. The average grain size of the martensite crystal grains belonging to the third group is preferably less than or equal to 0.70m. The average grain size of the martensite crystal grains belonging to the third group is more preferably less than or equal to 0.65 μm.

An aspect ratio of each of the martensite crystal grains belonging to the third group is less than or equal to 2.45. The aspect ratio of each of the martensite crystal grains belonging to the third group is preferably less than or equal to 2.40. The aspect ratio of each of the martensite crystal grains belonging to the third group is more preferably less than or equal to 2.35.

The average crystal grain size of the martensite crystal grains belonging to the first group (third group) and the aspect ratio of each of the martensite crystal grains belonging to the first group (third group) are measured using an EBSD (Electron Backscattered Diffraction) method.

This will be described more in detail as follows. First, a cross section image (hereinafter, referred to as “EBSD image”) in quench-hardened layer 50 is captured based on the EBSD method. The EBSD image is captured to include a sufficient number (more than or equal to 20) of martensite crystal grains. A boundary between adjacent martensite crystal grains is specified based on the EBSD image. Second, based on the specified boundary between the martensite crystal grains, the area and shape of each martensite crystal grain in the EBSD image are calculated.

More specifically, by calculating the square root of a value obtained by dividing the area of each martensite crystal grain in the EBSD image by π/4, the equivalent circle diameter of each martensite crystal grain in the EBSD image is calculated.

Based on the equivalent circle diameter of each martensite crystal grain calculated as described above, the martensite crystal grains belonging to the first group (third group) among the martensite crystal grains in the EBSD image are determined. The value obtained by dividing, by the total area of the martensite crystal grains in the EBSD image, the total area of the martensite crystal grains belonging to the first group (third group) among the martensite crystal grains in the EBSD image is regarded as the value obtained by dividing the total area of the martensite crystal grains belonging to the first group (third group) by the total area of the plurality of martensite crystal grains.

Based on the equivalent circle diameter of each martensite crystal grain calculated as described above, the martensite crystal grains in the EBSD image are classified into the first group and the second group (or classified into the third group and the fourth group). The value obtained by dividing, by the number of the martensite crystal grains classified into the first group (third group) in the EBSD image, the total of the equivalent circle diameters of the martensite crystal grains classified into the first group (third group) in the EBSD image is regarded as the average grain size of the martensite crystal grains belonging to the first group (third group).

From the shape of each martensite crystal grain in the EBSD image, the shape of each martensite crystal grain in the EBSD image is approximated to an ellipse by the least squares method. This approximation to an ellipse by the least squares method is performed in accordance with a method described in S. Biggin and D. J. Dingley, Journal of Applied Crystallography, (1977) 10, 376-378. By dividing the size in the major axis by the size in the minor axis in this elliptical shape, the aspect ratio of each martensite crystal grain in the EBSD image is calculated. A value obtained by dividing the total of the aspect ratios of the martensite crystal grains classified into the first group (third group) in the EBSD image by the number of the martensite crystal grains classified into the first group (third group) in the EBSD image is regarded as the average aspect ratio of the martensite crystal grains belonging to the first group (third group).

Quench-hardened layer 50 contains nitrogen. An average nitrogen concentration of quench-hardened layer 50 is, for example, more than or equal to 0.05 mass % between the surface (inner ring raceway surface 10c) of quench-hardened layer 50 and a position at a distance of 10 μm from the surface. Preferably, this average nitrogen concentration is more than or equal to 0.10 mass %. More preferably, this average nitrogen concentration is less than or equal to 0.20 mass %. It should be noted that this average nitrogen concentration is measured using an EPMA (Electron Probe Micro Analyzer).

An average carbon concentration of quench-hardened layer 50 between the surface (inner ring raceway surface 10c) of quench-hardened layer 50 and the position at a distance of 10 μm from the surface is, for example, more than or equal to 0.5 mass %. It should be noted that this average carbon concentration is measured using the EPMA.

The hardness of quench-hardened layer 50 in the surface (inner ring raceway surface 10c) is more than or equal to 670 Hv. The hardness is preferably more than or equal to 730 Hv. It should be noted that the hardness of quench-hardened layer 50 in the surface is measured in accordance with JIS (JIS Z 2244: 2009). The hardness of quench-hardened layer 50 in the surface is measured at a position as close to the surface as possible to such an extent that an indentation formed by a micro Vickers hardness meter does not extend beyond the surface of quench-hardened layer 50 at the central position in the rolling surface axial direction.

In the above example, quench-hardened layer 50 is formed in inner ring raceway surface 10c, but quench-hardened layer 50 may also be formed in each of outer ring raceway surface 20c and outer circumferential surface 30a (the rolling contact surface of rolling element 30). In other words, the quench-hardened layer may be formed in at least one of inner ring raceway surface 10c, outer ring raceway surface 20c, and the raceway surface of rolling element 30.

<Modification>

The following describes a configuration of a rolling bearing (referred to as “rolling bearing 200”) according to a first modification as well as a configuration of a rolling bearing (referred to as “rolling bearing 300”) according to a second modification. Here, differences from the configuration of rolling bearing 100 will be mainly described, and the same description will not be repeated.

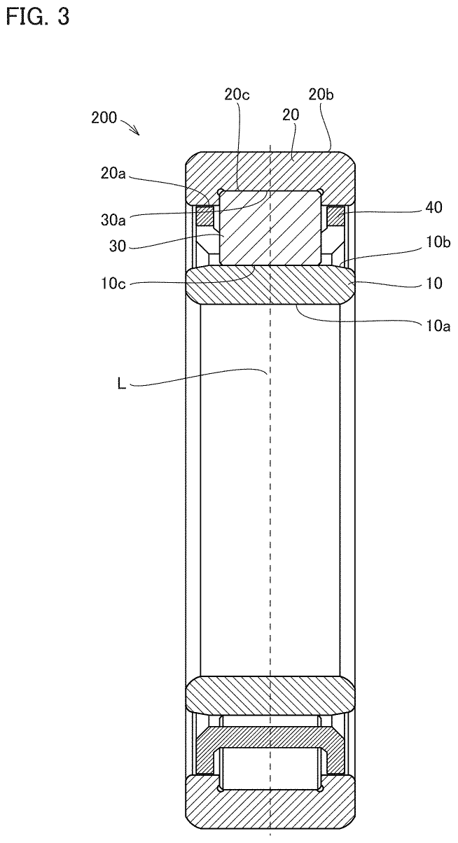

FIG. 3 is a cross sectional view of rolling bearing 200. As shown in FIG. 3, rolling bearing 200 includes an inner ring 10, an outer ring 20, rolling elements 30, and a cage 40. Rolling bearing 200 is a cylindrical roller bearing. That is, each rolling element 30 has a cylindrical shape having an outer circumferential surface 30a. Although not shown, rolling bearing 200 has a quench-hardened layer 50 formed in at least one of inner ring raceway surface 10c, outer ring raceway surface 20c, and the raceway surface (outer circumferential surface 30a) of rolling element 30. Although rolling bearing 200 is such a different type of bearing, rolling bearing 200 has the same configuration as that of rolling bearing 100.

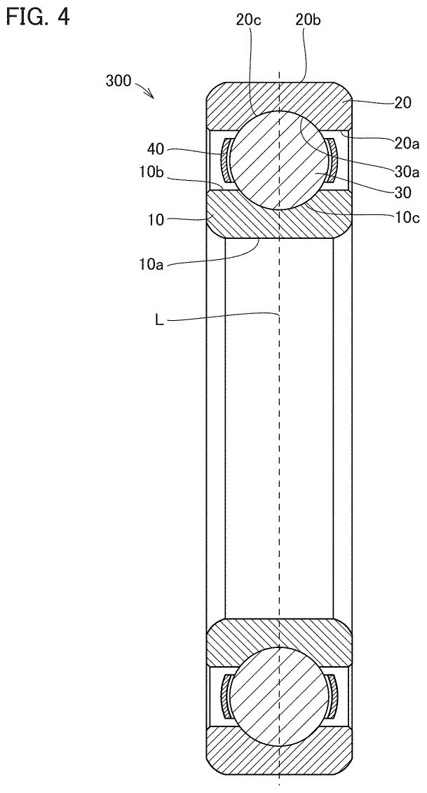

FIG. 4 is a cross sectional view of rolling bearing 300. As shown in FIG. 4, rolling bearing 300 includes an inner ring 10, an outer ring 20, rolling elements 30, and a cage 40. Rolling bearing 300 is a deep groove ball bearing. That is, rolling element 30 is a ball having a surface 30b. Although not shown, rolling bearing 300 has a quench-hardened layer 50 formed in at least one of inner ring raceway surface 10c, outer ring raceway surface 20c, and the raceway surface (outer circumferential surface 30a) of rolling element 30. Although rolling bearing 300 is such a different type of bearing, rolling bearing 300 has the same configuration as that of rolling bearing 100.

It should be noted that when quench-hardened layer 50 is formed in surface 30b, the volume ratio of the austenite crystal grains in the surface of quench-hardened layer 50 and the hardness of quench-hardened layer 50 may not be measured at the central position in the rolling surface axial direction. More specifically, the position of measurement of the volume ratio of the austenite crystal grains is not particularly limited as long as the volume ratio of the austenite crystal grains is measured between surface 30b and a position at a distance of 50 μm from surface 30b. The value of measurement of the hardness of quench-hardened layer 50 is not particularly limited as long as the hardness of quench-hardened layer 50 is measured at a position as close to surface 30b as possible to such an extent that an indentation formed by a micro Vickers hardness meter does not extend beyond surface 30b. This is because rolling element 30 has a spherical shape in rolling bearing 300.

Hereinafter, a method for manufacturing inner ring 10 will be described.

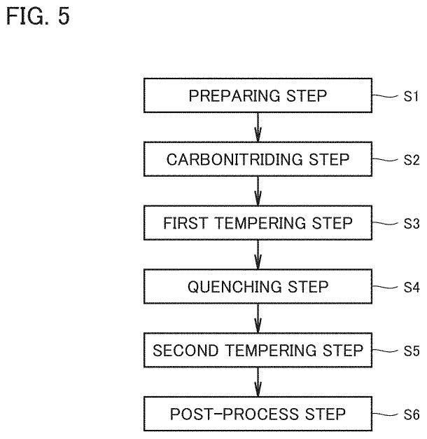

FIG. 5 is a process chart showing the method for manufacturing inner ring 10. As shown in FIG. 5, the method for manufacturing inner ring 10 includes a preparing step S1, a carbonitriding step S2, a first tempering step S3, a quenching step S4, a second tempering step S5, and a post-process step S6.

In preparing step S1, a processing target member having a cylindrical shape is prepared. The processing target member is formed into inner ring 10 by performing carbonitriding step S2, first tempering step S3, quenching step S4, second tempering step S5 and post-process step S6 thereto. In preparing step S1, first, the processing target member is subjected to hot forging. In preparing step S1, second, the processing target member is subjected to cold forging. In preparing step S1, third, cutting is performed to provide the processing target member with a shape close to the shape of inner ring 10.

In carbonitriding step S2, first, by heating the processing target member to a temperature of more than or equal to a first temperature, the processing target member is carbonitrided. The first temperature is a temperature of more than or equal to an A₁ transformation point of the steel of the processing target member. In carbonitriding step S2, second, the processing target member is cooled. This cooling is performed such that the temperature of the processing target member becomes less than or equal to an Ms transformation point.

In first tempering step S3, the processing target member is tempered. First tempering step S3 is performed by holding the processing target member at a second temperature for a first period of time. The second temperature is a temperature of less than the A₁ transformation point. The second temperature is more than or equal to 160° C. and less than or equal to 200° C., for example. The first period of time is more than or equal to 1 hour and less than or equal to 4 hours, for example.

In quenching step S4, the processing target member is quenched. In quenching step S4, first, the processing target member is heated to a third temperature. The third temperature is a temperature of more than or equal to the A₁ transformation point of the steel of the processing target member. The third temperature is preferably lower than the first temperature. In quenching step S4, second, the processing target member is cooled. This cooling is performed such that the temperature of the processing target member becomes less than or equal to the Ms transformation point.

In second tempering step S5, the processing target member is tempered. Second tempering step S5 is performed by holding the processing target member at a fourth temperature for a second period of time. The fourth temperature is a temperature of less than the A₁ transformation point. The fourth temperature is more than or equal to 160° C. and less than or equal to 200° C., for example. The second period of time is more than or equal to 1 hour and less than or equal to 4 hours, for example. It should be noted that each of quenching step S4 and second tempering step S5 may be repeated multiple times.

In post-process step S6, the processing target member is post-processed. In post-process step S6, cleaning of the processing target member, machining of a surface of the processing target member, such as grinding or polishing, and the like are performed, for example. In this way, inner ring 10 is manufactured.

Since each of a method for manufacturing outer ring 20 and a method for manufacturing rolling element 30 is the same as the method for manufacturing inner ring 10, each of the methods will not be described in detail here.

(Effect of Rolling Bearing according to Embodiment)

Hereinafter, effects of rolling bearing 100 will be described.

When material failure is considered in accordance with the weakest link model, portions each having a relatively low strength, i.e., martensite crystal grains each having a relatively large crystal grain size have a great influence on the material failure. In quench-hardened layer 50, the average grain size of the martensite crystal grains belonging to the first group (third group) is less than or equal to 0.97 μm (less than or equal to 0.75 μm). Accordingly, in rolling bearing 100, even such relatively large martensite crystal grains belonging to the first group (third group) are fine crystal grains, with the result that rolling fatigue strength and static load capacity are improved.

As the average aspect ratio of the martensite crystal grains becomes smaller, the shape of each of the martensite crystal grains becomes closer to a spherical shape, with the result that stress concentration is less likely to take place. Accordingly, when the average aspect ratio of the martensite crystal grains belonging to the first group (third group) is less than or equal to 2.57 (less than or equal to 2.45), the rolling fatigue strength and static load capacity can be further improved.

In rolling bearing 100, the volume ratio of the austenite crystal grains in the surface of quench-hardened layer 50 at the central position in the rolling surface axial direction is less than or equal to 30%, so that the hardness of quench-hardened layer 50 in the surface can be suppressed from being decreased (more specifically, the hardness of more than or equal to 670 Hv can be maintained).

It should be noted that since each of rolling bearing 200 and rolling bearing 300 has the same configuration as that of rolling bearing 100 except for the type of bearing, the rolling fatigue life and the static load capacity are improved in the same manner as in rolling bearing 100.

Hereinafter, a rolling fatigue test and a static load capacity test performed to confirm the effects of rolling bearing 100 will be described.

<Samples>

In each of the rolling fatigue test and the static load capacity test, samples 1, 2, and 3 were used. Each of samples 1 and 2 was composed of SUJ2. Sample 3 was composed of SCM435, which is a chromium-molybdenum steel defined in JIS (JIS G 4053: 2016).

Sample 1 was prepared by performing the same heat treatment as that for inner ring 10 (outer ring 20, or rolling element 30). More specifically, in the preparation of sample 1, the first temperature was set to 850° C., the second temperature was set to 180° C., the third temperature was set to 810° C., and the fourth temperature was set to 180° C. For each of samples 2 and 3, quenching step S4 and second tempering step S5 were not performed. In the preparation of sample 2, the first temperature was set to 850° C. and the second temperature was set to 180° C. In the preparation of sample 3, the first temperature was set to 930° C. and the second temperature was set to 170° C. The heat treatment conditions for samples 1 to 3 are shown in Table 1.

TABLE 1

| | First | Second | Third | Fourth |
|---|---|---|---|---|
| | Temperature | Temperature | Temperature | Temperature |
| | (° C.) | (° C.) | (° C.) | (° C.) |
| Sample 1 | 850 | 180 | 810 | 180 |
| Sample 2 | 850 | 180 | — | — |
| Sample 3 | 930 | 170 | — | — |

It should be noted that in each of samples 1 to 3, at a position at a distance of 50 μm from the surface, the ratio of the total area of the austenite crystal grains was more than or equal to 20% and less than or equal to 30%, the nitrogen concentration in the surface was more than or equal to 0.15 mass % and less than or equal to 0.20 mass %, and the hardness in the surface was 730 Hv.

In sample 1, the average grain size of the martensite crystal grains belonging to the first group was 0.80 μm, and the average aspect ratio of the martensite crystal grains belonging to the first group was 2.41. Moreover, in sample 1, the average grain size of the martensite crystal grains belonging to the third group was 0.64 μm, and the average aspect ratio of the martensite crystal grains belonging to the third group was 2.32.

In sample 2, the average grain size of the martensite crystal grains belonging to the first group was 1.11 μm, and the average aspect ratio of the martensite crystal grains belonging to the first group was 3.00. Moreover, in sample 2, the average grain size of the martensite crystal grains belonging to the third group was 0.84 μm, and the average aspect ratio of the martensite crystal grains belonging to the third group was 2.77.

In sample 3, the average grain size of the martensite crystal grains belonging to the first group was 1.81 μm, and the average aspect ratio of the martensite crystal grains belonging to the first group was 3.38. Moreover, in sample 2, the average grain size of the martensite crystal grains belonging to the third group was 1.28 μm, and the average aspect ratio of the martensite crystal grains belonging to the third group was 3.04.

Table 2 shows results of measurements of the average grain size and average aspect ratio of the martensite crystal grains in each of samples 1 to 3.

TABLE 2

| | First Group of Martensite | | Third Group of Martensite | |
|---|---|---|---|---|
| | Crystal Grains | | Crystal Grains | |
| | Average | Average | Average | Average |
| | Grain | Aspect | Grain | Aspect |
| | Size (μm) | Ratio | Size (μm) | Ratio |
| Sample 1 | 0.80 | 2.41 | 0.64 | 2.32 |
| Sample 2 | 1.11 | 3.00 | 0.84 | 2.77 |
| Sample 3 | 1.81 | 3.38 | 1.28 | 3.04 |

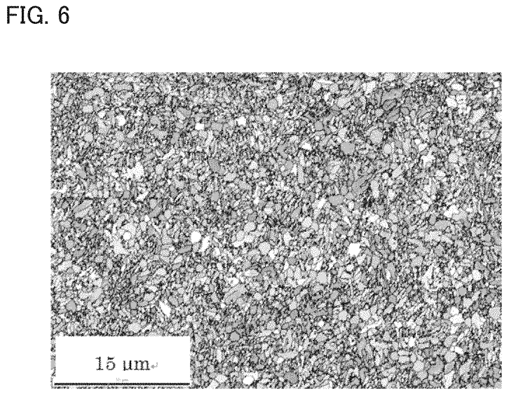

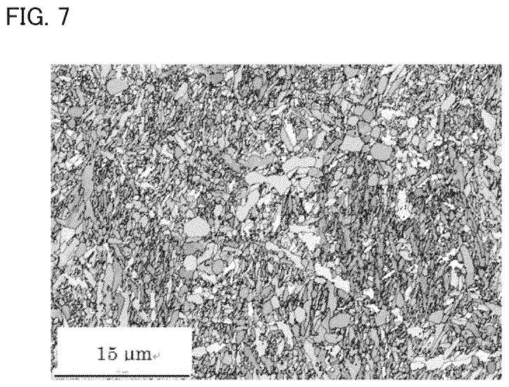

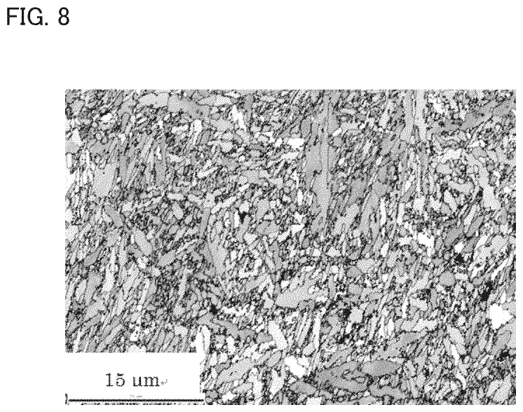

FIG. 6 shows an EBSD image at a cross section of sample 1. FIG. 7 shows an EBSD image at a cross section of sample 2. FIG. 8 shows an EBSD image at a cross section of sample 3. As shown in FIG. 6 to FIG. 8, it is understood that the martensite crystal grains in sample 1 are finer than those in each of samples 2 and 3.

<Rolling Fatigue Test Conditions>

In the rolling fatigue test, an inner ring, an outer ring, and a tapered roller were prepared using each of samples 1 and 3, and were used to produce a tapered roller bearing. The rolling fatigue test was performed under conditions that the rotating speed of the inner ring was 3000 rotations/min and the maximum contact pressure was 2.6 GPa. In the rolling fatigue test, bath lubrication was performed using VG56, which is a turbine oil. In this turbine oil, hard gas-atomized powder was mixed at a ratio of 0.2 g/l. The test conditions for the rolling fatigue test are shown in Table 3. It should be noted that the rolling fatigue test was performed onto six tapered roller bearings each produced using sample 1 and six tapered roller bearings each produced using sample 3.

TABLE 3

| | |
|---|---|
| Maximum Contact | 2.6 |
| Pressure (GPa) | |
| Rotating Speed | 3000 |
| of Inner Ring | |
| (min⁻¹) | |
| Lubrication | Bath Lubrication with Turbine Oil (VG56) |
| Special Note | 0.2 g/l of Hard Gas-Atomized Powder |
| | is Mixed in Lubricating Oil. |

<Static Load Capacity Test Conditions>

In the static load capacity test, flat plate-like members were produced using samples 1 to 3. The static load capacity test was performed by finding a relation between the maximum contact pressure and the indentation depth by pressing a ceramic ball composed of silicon nitride against a surface of each of the flat plate-like members having been mirror-finished. It should be noted that the static load capacity was evaluated in accordance with the maximum contact pressure when a value obtained by dividing the indentation depth by the diameter of the ceramic ball reached 1/10000 (when a value obtained by dividing the indentation depth by the diameter of the ceramic ball and multiplying by 10000 reached 1).

<Rolling Fatigue Test Results>

Each of the tapered roller bearings prepared using sample 1 had an L₅₀ life (50% failure life) of 50.4 hours. On the other hand, each of the tapered roller bearings prepared using sample 3 had an L₅₀ life of 31.2 hours. Thus, each of the tapered roller bearings produced using sample 1 had a rolling fatigue life improved twice or more as compared with that in each of the tapered roller bearings produced using sample 3. This test result is shown in Table 4.

TABLE 4

| | Sample 1 | Sample 3 |
|---|---|---|
| L₅₀ Life (Hours) | 50.4 | 31.2 |
| Number of Samples for Test | 6 | 6 |

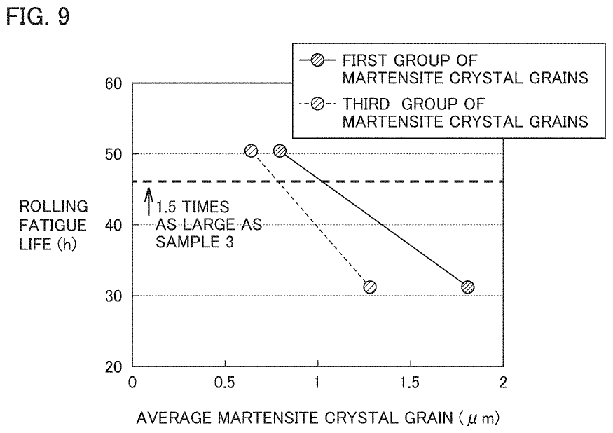

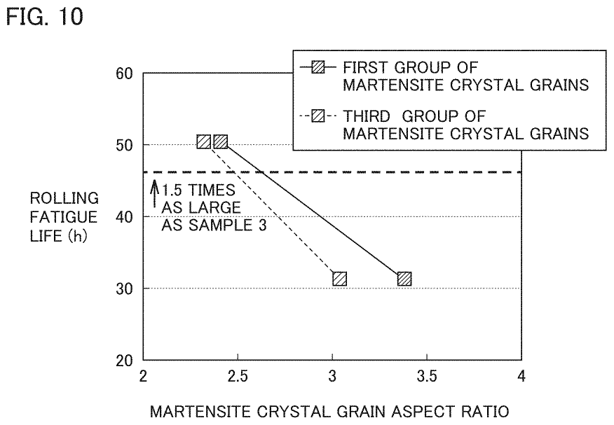

FIG. 9 is a graph showing a relation between the average grain size of the martensite crystal grains and the rolling fatigue life. FIG. 10 is a graph showing a relation between the average aspect ratio of the martensite crystal grains and the rolling fatigue life. In FIG. 9, the horizontal axis represents the average grain size (unit: μm) of the martensite crystal grains, and the vertical axis represents rolling fatigue life L₅₀ (unit: hour). In FIG. 10, the horizontal axis represents the average aspect ratio of the martensite crystal grains, and the vertical axis represents rolling fatigue life L₅₀ (unit: hour).

As shown in FIG. 9 and FIG. 10, rolling fatigue life L₅₀ was more improved as the average grain size of the martensite crystal grains belonging to the first group (third group) was smaller, and rolling fatigue life L₅₀ was more improved as the average aspect ratio of the martensite crystal grains belonging to the first group (third group) was smaller.

<Static Load Capacity Test Results>

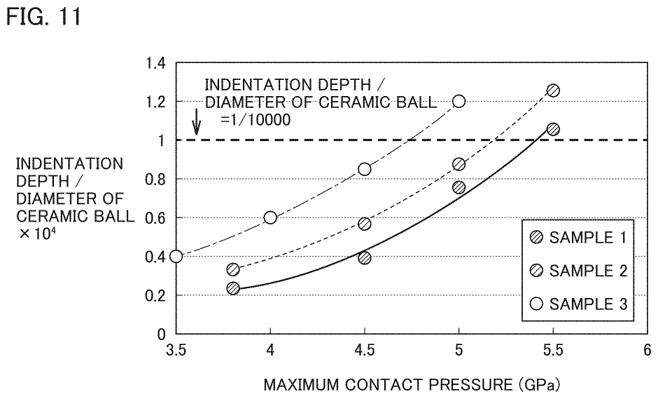

FIG. 11 is a graph showing a relation between the maximum contact pressure and the indentation depth. In FIG. 11, the horizontal axis represents the maximum contact pressure (unit: GPa), and the vertical axis represents a value obtained as follows: the indentation depth/the diameter of the ceramic ball×10⁴. As shown in

FIG. 11, when the value of the vertical axis was 1, the value of the maximum contact pressure in a curve corresponding to sample 1 was larger than those in curves corresponding to samples 2 and 3. That is, the value of the static load capacity in sample 1 was larger than each of those in samples 2 and 3.

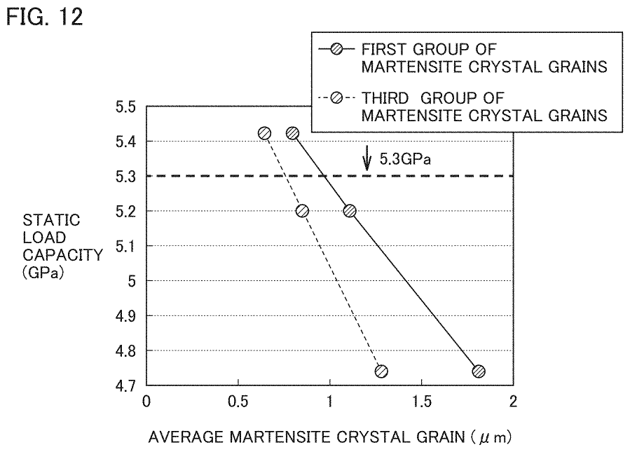

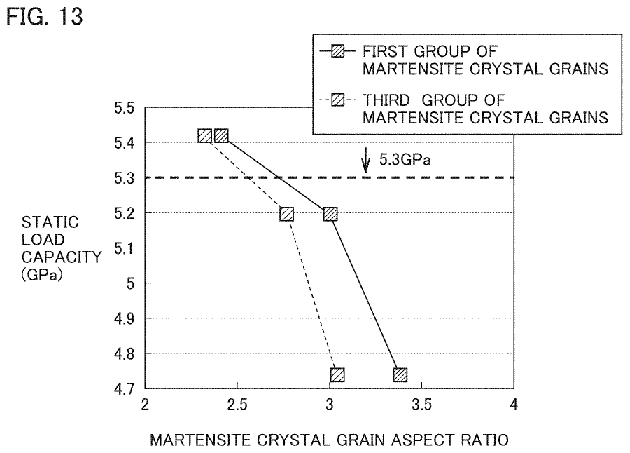

FIG. 12 is a graph showing a relation between the average grain size of the martensite crystal grains and the static load capacity. FIG. 13 is a graph showing a relation between the average aspect ratio of the martensite crystal grains and the static load capacity. In FIG. 12, the horizontal axis represents the average grain size (unit: μm) of the martensite crystal grains, and the vertical axis represents the static load capacity (unit: GPa). In FIG. 13, the horizontal axis represents the average aspect ratio of the martensite crystal grains, and the vertical axis represents the static load capacity (unit: GPa).

As shown in FIG. 12 and FIG. 13, the static load capacity was more improved as the average grain size of the martensite crystal grains belonging to the first group (third group) was smaller, and the static load capacity was more improved as the average aspect ratio of the martensite crystal grains belonging to the first group (third group) was smaller. In view of this as well as the results shown in FIG. 9 and FIG. 10, when the average grain size of the martensite crystal grains belonging to the first group (third group) is less than or equal to 0.97 μm (less than or equal to 0.75 μm) and the average aspect ratio of the martensite crystal grains belonging to the first group (third group) is less than or equal to 2.57 (less than or equal to 2.45), it is possible to achieve a rolling fatigue life L₅₀ that is 1.5 or more times as large as rolling fatigue life L₅₀ of the conventional one (i.e., rolling fatigue life L₅₀ of sample 3) and it is possible to achieve a static load capacity of more than or equal to 5.3 GPa.

In view of such test results, it was also experimentally indicated that the rolling fatigue strength and static load capacity of rolling bearing 100 are improved by providing quench-hardened layer 50.

Although the embodiments of the present invention have been illustrated, the embodiments described above can be modified in various manners. Further, the scope of the present invention is not limited to the above-described embodiments. The scope of the present invention is defined by the terms of the claims, and is intended to include any modifications within the scope and meaning equivalent to the terms of the claims.

### INDUSTRIAL APPLICABILITY

The above-described embodiment is particularly advantageously applied to a tapered roller bearing, a cylindrical roller bearing, and a deep groove ball bearing.

### REFERENCE SIGNS LIST

10: inner ring; 10a: inner circumferential surface; 10b: outer circumferential surface; 10c: inner ring raceway surface; 20: outer ring; 20a: inner circumferential surface; 20b: outer circumferential surface; 20c: outer ring raceway surface; 30: rolling element; 30a: outer circumferential surface; 30b: surface; 40: cage; 50: quench-hardened layer; 100, 200, 300: rolling bearing; L: imaginary straight line; S1: preparing step; S2: carbonitriding step; S3: first tempering step; S4: quenching step; S5: second tempering step; S6: post-process step.

1. A rolling bearing comprising an inner ring, an outer ring, and a rolling element, each of the inner ring, the outer ring, and the rolling element being composed of a steel, the rolling bearing having a quench-hardened layer in at least one of an inner ring raceway surface of the inner ring, an outer ring raceway surface of the outer ring, and a rolling contact surface of the rolling element, wherein
the rolling bearing is a tapered roller bearing, a cylindrical roller bearing, or a deep groove ball bearing,
the quench-hardened layer includes a plurality of martensite crystal grains and a plurality of austenite crystal grains,
a ratio of a total area of the plurality of martensite crystal grains in the quench-hardened layer is more than or equal to 70%,
the plurality of martensite crystal grains are classified into a first group and a second group,
a minimum value of crystal grain sizes of the martensite crystal grains belonging to the first group is larger than a maximum value of crystal grain sizes of the martensite crystal grains belonging to the second group,
a value obtained by dividing a total area of the martensite crystal grains belonging to the first group by the total area of the plurality of martensite crystal grains is more than or equal to 0.5,
a value obtained by dividing, by the total area of the plurality of martensite crystal grains, a total area of the martensite crystal grains belonging to the first group except for a martensite crystal grain that has a minimum crystal grain size and that belongs to the first group is less than 0.5,
an average grain size of the martensite crystal grains belonging to the first group is less than or equal to 0.97 μm,
a hardness of the quench-hardened layer is more than or equal to 670 Hv in a surface of the quench-hardened layer at a central position in a rolling surface axial direction, and
a volume ratio of the austenite crystal grains in the quench-hardened layer is less than or equal to 30% in the surface of the quench-hardened layer at the central position in the rolling surface axial direction.

2. The rolling bearing according to claim 1, wherein an average aspect ratio of the martensite crystal grains belonging to the first group is less than or equal to 2.57.

3. A rolling bearing comprising an inner ring, an outer ring, and a rolling element, each of the inner ring, the outer ring, and the rolling element being composed of a steel, the rolling bearing having a quench-hardened layer in at least one of an inner ring raceway surface of the inner ring, an outer ring raceway surface of the outer ring, and a rolling contact surface of the rolling element, wherein
the rolling bearing is a tapered roller bearing, a cylindrical roller bearing, or a deep groove ball bearing,
the quench-hardened layer includes a plurality of martensite crystal grains and a plurality of austenite crystal grains,
a ratio of a total area of the plurality of martensite crystal grains in the quench-hardened layer is more than or equal to 70%,
the plurality of martensite crystal grains are classified into a third group and a fourth group,
a minimum value of crystal grain sizes of the martensite crystal grains belonging to the third group is larger than a maximum value of crystal grain sizes of the martensite crystal grains belonging to the fourth group,
a value obtained by dividing a total area of the martensite crystal grains belonging to the third group by the total area of the plurality of martensite crystal grains is more than or equal to 0.7,
a value obtained by dividing, by the total area of the plurality of martensite crystal grains, a total area of the martensite crystal grains belonging to the third group except for a martensite crystal grain that has a minimum crystal grain size and that belongs to the third group is less than 0.7,
an average grain size of the martensite crystal grains belonging to the third group is less than or equal to 0.75
a hardness of the quench-hardened layer is more than or equal to 670 Hv in a surface of the quench-hardened layer at a central position in a rolling surface axial direction, and
a volume ratio of the austenite crystal grains in the quench-hardened layer is less than or equal to 30% in the surface of the quench-hardened layer at the central position in the rolling surface axial direction.

4. The rolling bearing according to claim 3, wherein an average aspect ratio of the martensite crystal grains belonging to the third group is less than or equal to 2.45.

5. The rolling bearing according to claim 1, wherein
the quench-hardened layer contains nitrogen, and
an average nitrogen concentration of the quench-hardened layer is more than or equal to 0.05 mass % between the surface and a position at a distance of 10 μm from the surface.

6. The rolling bearing according to claim 1, wherein an average carbon concentration of the quench-hardened layer is more than or equal to 0.5 mass % between the surface and a position at a distance of 10 μm from the surface.

7. The rolling bearing according to claim 1, wherein the steel is a high carbon chromium bearing steel SUJ2 defined in JIS.
